(19) United States
(12) Patent Application Publication
(10) Pub. No.: US 2010/0231797 A1
(43) Pub. Date: Sep. 16, 2010

(54) VIDEO TRANSITION ASSISTED ERROR RECOVERY FOR VIDEO DATA DELIVERY

(75) Inventors: Wenqing Jiang, San Jose, CA (US); Zhengran Li, San Jose, CA (US); Hua Jiang, San Jose, CA (US); Li Hao, Cupertino, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/560,795

(22) Filed: Sep. 16, 2009

Related U.S. Application Data
(60) Provisional application No. 61/158,956, filed on Mar. 10, 2009.

(51) Int. Cl. H04N 5/217

(52) U.S. Cl. 348/607; 348/E05.078

(57) ABSTRACT

Techniques for video data delivery are provided. A first data stream is received that includes a plurality of video data frames. At least one corrupted video data frame is detected in the first data stream. At least one replacement video data frame is generated for the corrupted video data frame(s) based at least on a non-corrupted video data frame received in the first data stream prior to the corrupted video data frame(s). The replacement video data frame(s) include a modified form of the non-corrupted video data frame, and are configured to provide a smooth scene transition from the non-corrupted video data frame. The corrupted video data frame(s) are replaced in the first data stream with the generated replacement video data frame(s) to generate a second data stream.

This application claims the benefit of U.S. Provisional Application No. 61/158,956, filed on Mar. 10, 2009, which is incorporated by reference herein in its entirety.

### BACKGROUND OF THE INVENTION

1. Field of the Invention

The present invention relates to error recovery for video data.

2. Background Art

Many types of electronic devices, including cell phones, computers, and high definition televisions are being produced that are capable of displaying video received in the form of digital data. Tremendous growth has occurred in the video data delivery space to meet the demand for video by such electronic devices. As a result, many video data delivery applications have been developed for providing video data over a wide range of communication networks. Examples of such applications include video streaming/live video broadcasting over the Internet, and video/teleconferencing over both circuit-switched and packet-switched wireless data links.

Video that is delivered over an unreliable data link may be displayed with poor picture quality. For example, a video telephony application delivered over a wireless network may have choppy video quality and may be undesirable to view at times. Problems with the display of such video can be attributed to many factors, including the loss of data in-transit to the displaying electronic device. Video data loss due to network congestion and/or noise interference/corruption for data transmitted over the air interface is common. Thus, it is becoming increasingly desirable for video data delivery systems to incorporate data recovery mechanisms when such data loss occurs.

One typical approach to video data recovery is to freeze the displayed image when video data is lost or is not arriving in time. As such, viewers of the displayed image may notice an undesirable freezing of the displayed image, unless the video content conveyed at that particular point of time happened to be unchanging. Another typical approach to data recovery is to attempt to recover any corrupted video data using spatial and/or temporal prediction technologies. Such an approach is limited because the transmitted video data is typically highly compressed before transmission, and thus relatively little correlation may exist to aid in predictions performed by a receiver. In still another typical approach to data recovery, redundant information is transmitted and/or stronger error correction capability is provided. One example of a system providing increased data redundancy/error correction is described in the 3G-324M specification for circuit switched video telephony over a 3G wireless network. However, approaches that provide data redundancy and/or error correction typically do so at the expense of increased bandwidth requirements, which is not desirable for some video applications. In particular, mobile electronic devices may have less bandwidth and/or computation resources, and thus may not be capable of handling error correction techniques that require higher bandwidth and/or lead to a higher computational burden.

### BRIEF SUMMARY OF THE INVENTION

Methods, systems, and apparatuses are described for video data delivery and recovery, substantially as shown in and/or described in connection with at least one of the figures, as set forth more completely in the claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example mobile device with video display and processing capability.

FIG. 2 shows a sensor array of an example image sensor device, having a two-dimensional array of pixel sensors.

FIG. 3 shows a block diagram representation of image data included in an image signal for an image captured by an image sensor device.

FIG. 4 shows a block diagram of a video data processing module, according to an example embodiment.

FIG. 5 illustrates a graphical representation of a video data stream having a corrupted video data frame, according to an example embodiment.

FIG. 6 illustrates a graphical representation of a video data stream having multiple corrupted video data frames in sequence, according to an embodiment.

FIG. 7 shows a flowchart for performing video data delivery, according to an example embodiment.

FIG. 8 shows a block diagram of a corrupted frame detector, according to an example embodiment.

FIG. 9 shows a process for generating replacement video data frames, according to an example embodiment.

FIG. 10 shows a block diagram of a replacement frame generator, according to an example embodiment.

FIG. 11 shows a flowchart for generating replacement video data frames having zoom effects, according to an example embodiment.

FIG. 12 shows a process for replacing corrupted video data frames, according to an example embodiment.

FIG. 13 shows a process for generating replacement video data frames having pan effects, according to an example embodiment.

FIG. 14 illustrates an example of panning across an image, according to an embodiment.

FIG. 15 shows a process for replacing corrupted video data frames, according to an example embodiment.

FIG. 16 shows a process for generating replacement video data frames having slide effects, according to an example embodiment.

FIG. 17 shows a process for generating replacement video data frames having cross-dissolve effects, according to an example embodiment.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Image Processing in Mobile Devices

Embodiments of the present invention relate to the processing of video data streams in devices. For example, embodiments include mobile devices where image/video data processing is typically performed with limited resources. Types of such mobile devices include mobile phones (e.g., cell phones), handheld computing devices (e.g., personal digital assistants (PDAs), BLACKBERRY devices, PALM devices, etc.), handheld music players (e.g., APPLE IPODs, MP3 players, etc.), compact video cameras, and further types of mobile devices. Such mobile devices may include a camera used to capture images, such as still images and video images. The captured images are processed internal to the mobile device. Alternatively or additionally, such mobile devices may receive video data from external sources, including in applications such as video telephony, digital television, etc. Although embodiments are frequently described herein as pertaining to mobile devices, embodiments may also be implemented in other devices, such as set top boxes and desktop computers, etc.

FIG. 1 shows a block diagram of an example mobile device 100 with video capture and processing capability. Mobile device 100 may be a mobile phone, a handheld computing device, a music player, etc. The implementation of mobile device 100 shown in FIG. 1 is provided for purposes of illustration, and is not intended to be limiting. Embodiments of the present invention are intended to cover devices having additional and/or alternative features to those shown for mobile device 100 in FIG. 1.

As shown in FIG. 1, mobile device 100 includes an image sensor device 102, an analog-to-digital (A/D) 104, an image processor 106, a speaker 108, a microphone 110, an audio codec 112, a central processing unit (CPU) 114, a radio frequency (RF) transceiver 116, an antenna 118, a display 120, a battery 122, a storage 124, and a keypad 126. These components are typically mounted to or contained in a housing. The housing may further contain a circuit board mounting integrated circuit chips and/or other electrical devices corresponding to these components. Note that one or more of these components may be implemented in multiple separate devices and/or may be combined together in a device. Each of these components of mobile device 100 is described as follows.

Battery 122 provides power to the components of mobile device 100 that require power. Battery 122 may be any type of battery, including one or more rechargeable and/or non-rechargeable batteries.

Keypad 126 is a user interface device that includes a plurality of keys enabling a user of mobile device 100 to enter data, commands, and/or to otherwise interact with mobile device 100. Mobile device 100 may include additional and/or alternative user interface devices to keypad 126, such as a touch pad, a roller ball, a stick, a click wheel, and/or voice recognition technology.

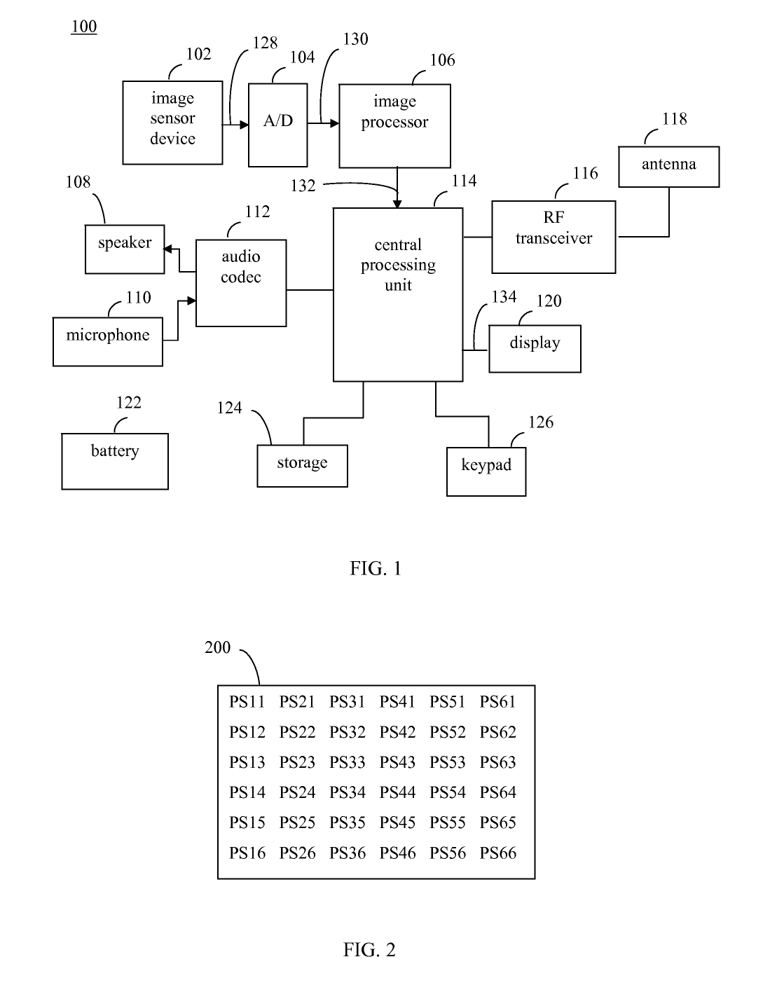

Image sensor device 102 is an image capturing device, and is optionally present. For example, image sensor device 102 may include an array of photoelectric light sensors, such as a charge coupled device (CCD) or a CMOS (complementary metal-oxide-semiconductor) sensor device. Image sensor device 102 typically includes a two-dimensional array of sensor elements organized into rows and columns. For example, FIG. 2 shows a sensor array 200, which is an example of image sensor device 102, having a two-dimensional array of pixel sensors (PS). Sensor array 200 is shown in FIG. 2 as a six-by-six array of thirty-six (36) pixel sensors for ease of illustration. Sensor array 200 may have any number of pixel sensors, including hundreds of thousands or millions of pixel sensors. Each pixel sensor is shown in FIG. 2 as “PSxy”, where “x” is a row number, and “y” is a column number, for any pixel sensor in the array of sensor elements. In embodiments, each pixel sensor of image sensor device 102 is configured to be sensitive to a specific color, or color range. In one example, three types of pixel sensors are present, including a first set of pixel sensors that are sensitive to the color red, a second set of pixel sensors that are sensitive to green, and a third set of pixel sensors that are sensitive to blue. Image sensor device 102 receives light corresponding to an image, and generates an analog image signal 128 corresponding to the captured image. Analog image signal 128 includes analog values for each of the pixel sensors.

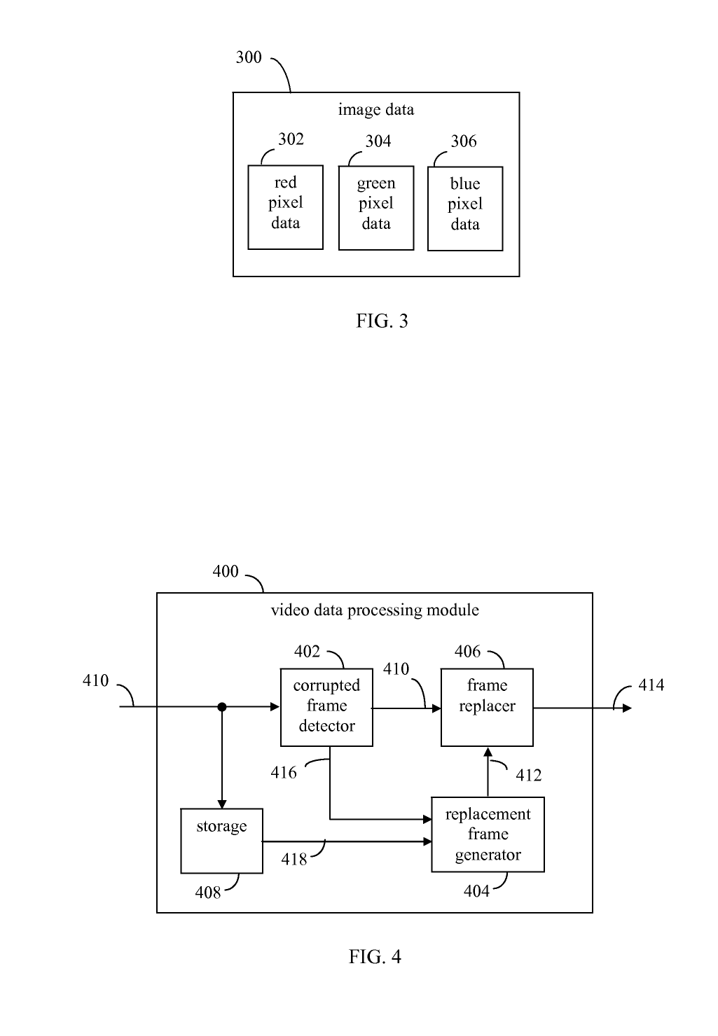

A/D 104 receives analog image signal 128, converts analog image signal 128 to digital form, and outputs a digital image signal 130. Digital image signal 130 includes digital representations of each of the analog values generated by the pixel sensors, and thus includes a digital representation of the captured image. For instance, FIG. 3 shows a block diagram representation of image data 300 included in digital image signal 130 for an image captured by image sensor device 102. As shown in FIG. 3, image data 300 includes red pixel data 302, green pixel data 304, and blue pixel data 306. Red pixel data 302 includes data related to pixel sensors of image sensor device 102 that are sensitive to the color red. Green pixel data 304 includes data related to pixel sensors of image sensor device 102 that are sensitive to the color green. Blue pixel data 306 includes data related to pixel sensors of image sensor device 102 that are sensitive to the color blue.

Image processor 106 receives digital image signal 130. Image processor 106 performs image processing of the digital pixel sensor data received in digital image signal 130. For example, image processor 106 may be used to generate pixels of all three colors at all pixel positions when a Bayer pattern image is output by image sensor device 102. Image processor 106 may perform a demosaicing algorithm to interpolate red, green, and blue pixel data values for each pixel position of the array of image data 200 shown in FIG. 2.

Image processor 106 performs processing of digital image signal 130, such as described above, and generates an image processor output signal 132. Image processor output signal 132 includes processed pixel data values that correspond to the image captured by image sensor device 102. Image processor output signal 132 includes color channels 502, 504, and 506, which each include a corresponding full array of pixel data values, respectively representing red, green, and blue color images corresponding to the captured image. Image processor output signal 132 may have the form of a stream of video data.

Note that in an embodiment, two or more of image sensor device 102, A/D 104, and image processor 106 may be included together in a single IC chip, such as a CMOS chip, particularly when image sensor device 102 is a CMOS sensor, or may be in two or more separate chips. For instance, FIG. 1 shows image sensor device 102, A/D 104, and image processor 106 included in a camera module 138, which may be a single IC chip in an example embodiment.

CPU 114 is shown in FIG. 1 as coupled to each of image processor 106, audio codec 112, RF transceiver 116, display 120, storage 124, and keypad 126. CPU 114 may be individually connected to these components, or one or more of these components may be connected to CPU 114 in a common bus structure.

Microphone 110 and audio CODEC 112 may be present in some applications of mobile device 100, such as mobile phone applications and video applications (e.g., where audio corresponding to the video images is recorded). Microphone 110 captures audio, including any sounds such as voice, etc. Microphone 110 may be any type of microphone. Microphone 110 generates an audio signal that is received by audio codec 112. The audio signal may include a stream of digital data, or analog information that is converted to digital form by an analog-to-digital (A/D) converter of audio codec 112. Audio codec 112 encodes (e.g., compresses) the received audio of the received audio signal. Audio codec 112 generates an encoded audio data stream that is received by CPU 114.

CPU 114 receives image processor output signal 132 from image processor 106 and receives the audio data stream from audio codec 112. As shown in FIG. 1, CPU 114 includes an image processor 136. In embodiments, image processor 136 performs image processing (e.g., image filtering) functions for CPU 114. In an embodiment, CPU 114 includes a digital signal processor (DSP), which may be included in image processor 136. When present, the DSP may apply special effects to the received audio data (e.g., an equalization function) and/or to the video data. CPU 114 may store and/or buffer video and/or audio data in storage 124. Storage 124 may include any suitable type of storage, including one or more hard disc drives, optical disc drives, FLASH memory devices, etc. In an embodiment, CPU 114 may stream the video and/or audio data to RF transceiver 116, to be transmitted from mobile device 100.

When present, RF transceiver 116 is configured to enable wireless communications for mobile device 116. For example, RF transceiver 116 may enable telephone calls, such as telephone calls according to a cellular protocol. RF transceiver 116 may include a frequency up-converter (transmitter) and down-converter (receiver). For example, RF transceiver 116 may transmit RF signals to antenna 118 containing audio information corresponding to voice of a user of mobile device 100. RF transceiver 116 may receive RF signals from antenna 118 corresponding to audio and/or video information received from another device in communication with mobile device 100. RF transceiver 116 provides the received audio and/or video information to CPU 114. For example, RF transceiver 116 may be configured to receive video telephony or television signals for mobile device 100, to be displayed by display 120. In another example, RF transceiver 116 may transmit images captured by image sensor device 102, including still and/or video images, from mobile device 100. In another example, RF transceiver 116 may enable a wireless local area network (WLAN) link (including an IEEE 802.11 WLAN standard link), and/or other type of wireless communication link.

CPU 114 provides audio data received by RF transceiver 116 to audio codec 112. Audio codec 112 performs bit stream decoding of the received audio data (if needed) and converts the decoded data to an analog signal. Speaker 108 receives the analog signal, and outputs corresponding sound.

Image processor 106, audio codec 112, and CPU 114 may be implemented in hardware, software, firmware, and/or any combination thereof. For example, CPU 114 may be implemented as a proprietary or commercially available processor, such as an ARM (advanced RISC machine) core configuration, that executes code to perform its functions. Audio codec 112 may be configured to process proprietary and/or industry standard audio protocols. Image processor 106 may be a proprietary or commercially available image signal processing chip, for example.

Display 120 receives image data from CPU 114, such as image data generated by image processor 106. For example, display 120 may be used to display images, including video, captured by image sensor device 102 and/or received by RF transceiver 116. Display 120 may include any type of display mechanism, including an LCD (liquid crystal display) panel or other display mechanism.

Depending on the particular implementation, image processor 106 formats the image data output in image processor output signal 132 according to a proprietary or known video data format. Display 120 is configured to receive the formatted data, and to display a corresponding captured image. In one example, image processor 106 may output a plurality of data words, where each data word corresponds to an image pixel. A data word may include multiple data portions that correspond to the various color channels for an image pixel. Any number of bits may be used for each color channel, and the data word may have any length.

### Example Video Data Delivery Embodiments

A video data frame is a digital representation of an image that is included in a stream of video data frames that make up a video. Video data frames in the video data stream may be displayed one after another to display the video. A corrupted video data frame is a video data frame that was partially or not entirely received (e.g., is missing data), and/or that includes erroneous data, and thus the image corresponding to the corrupted video data frame cannot be displayed properly. A corrupted video data frame may be corrupted at various levels of the video data frame, including being corrupted at the frame level (e.g., much of, or the entirety of the video data frame), at the slice level (e.g., a latitudinal section/row of a video data frame, which may have the shape of a horizontal stripe extending across the video data frame image), at the microblock level (e.g., video data of the video data frame corresponding to a square or rectangular region of a video data frame image), and/or at any other level.

Conventional video data recovery techniques for handling corrupted video data can be summarized as an objective optimization problem: given corrupted video data, determine the best approximation to the original video data based on particular criteria. Typically, the focus on video data recovery is on achieving visual fidelity to the original video data, be it objective or subjective, rather than on the end user experience. Because original video data may be lost, however, such a focus often leads to difficult problems without feasible solutions or highly resource demanding algorithms that are impractical to implement in resource limited devices, such as mobile handheld devices, such as cell phones, smart phones, handheld computers, etc.

While visual fidelity to the original video data is an important factor, some categories of video applications exist that do not have stringent requirements with regard to visual fidelity. Examples of such video applications include video telephony applications and video streaming For example, many Internet-based applications exist for streaming video for entertainment and/or other purpose, such as the website YouTube®, which may be accessed at www.youtube.com. In general, a one or two second loss of video data may not severely injure a video message conveyed across a communication link. However, it may be annoying to users to see frozen pictures or pictures with blocky artifacts that result from video data losses.

Embodiments overcome such limitations of conventional techniques for delivering and displaying video content. When corrupted video data is received, an approximation to the video content is generated that renders an improved end-user experience. In embodiments, various types of motion video transitions may be inserted into a video data stream to replace corrupted video data frames. In one example embodiment, for each corrupted frame of video data, a new frame is generated using one or more previously received good (non-corrupted) video frames. The new frames are generated in a manner such that they render a smooth scene transition, with motion, from non-corrupted video frames received previously. Examples of such transitions include zooming in/out, panning, sliding in/out, fading in/out, etc., although any type of video transitions appropriate for the video content may be used by default or at the discretion of the user.

In another embodiment, for each corrupted frame of video data, a new frame is generated based on at least one non-corrupted video frame received prior to the corrupted video frame(s) and at least one non-corrupted video frame received after the corrupted video frame(s). The replacement video data frames are generated in such a manner that they render a smooth motion/scene transition from the prior-received non-corrupted video frame(s) to the after-received non-corrupted video frames. Example transitions include zooming in/out, panning, sliding in/out, fading in/out, cross-dissolving, etc., although any type of video transitions appropriate for the video content may be used by default or at the discretion of the user.

In general, when viewing a video using a video communication application, consumers take away a visual memory and a message/information regarding the video communication. By replacing corrupted frames of a video with replacement video frames, embodiments described herein may modify the provided visual communication when compared to the original video. However, embodiments described herein do not substantially modify the information originally intended to be provided by the original video. Typically, the corrupted video frames amount to a relatively short time duration of the overall video communication. Thus the replacement video data frames that are generated cover this relatively short time duration, and are not substantial enough to affect the intended message of the video.

For example, FIG. 4 shows a block diagram of a video data processing module 400, according to an example embodiment. Video data processing module 400 is configured to generate video data frames used to replace the corrupted video data frames to enable smooth motion scene transitions. In embodiments, video data processing module 402 may be a separate entity, or may be included in another processing entity, such as image processor 106, CPU 114, and/or in further video data processing and/or video data delivery portions of electronic devices. As shown in FIG. 4, video data processing module 400 includes a corrupted frame detector 402, a replacement frame generator 404, a frame replacer 406, and storage 408. These elements of video data processing module 400 are described as follows.

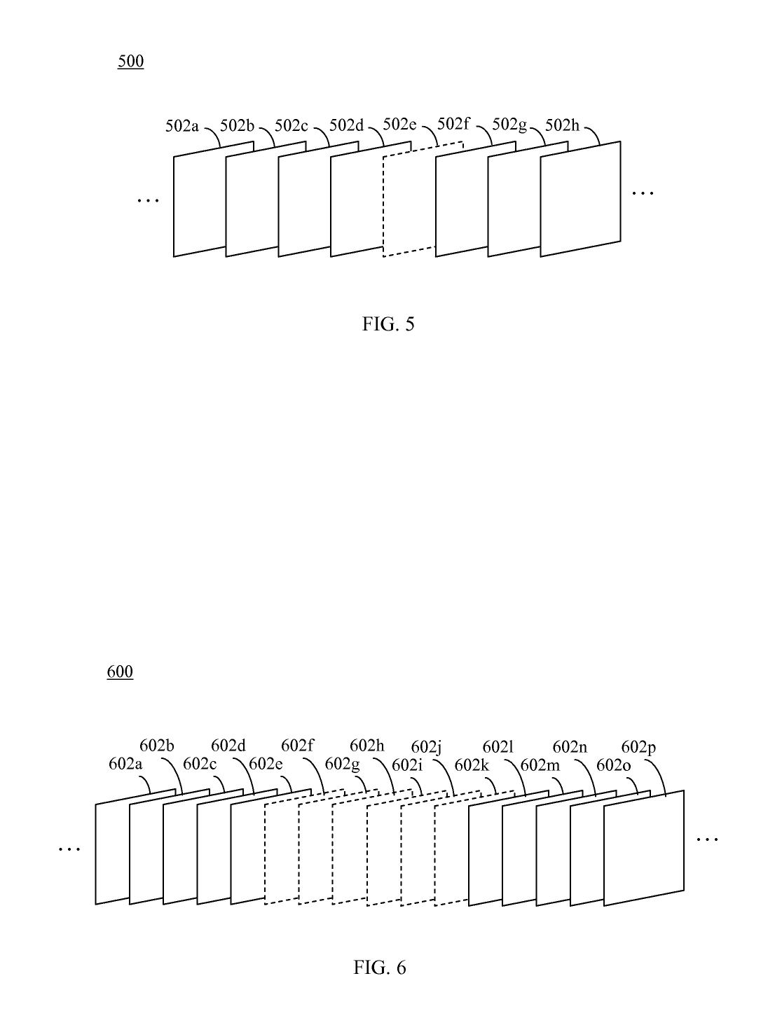

As shown in FIG. 4, corrupted frame detector 402 is configured to receive a first data stream 410. First data stream 410 includes a plurality of video data frames. Images corresponding to the video data frames can be displayed successively to produce a video corresponding to first data stream 410. FIG. 5 illustrates a graphical representation of a video data stream 500, according to an embodiment. Video data stream 500 is an example of first data stream 410. As shown in FIG. 5, video data stream 500 includes a plurality of video data frames 502a-502h. In the example of FIG. 5, video data frame 502a is the first received video data frame, video data frame 502b is the second received video data frame, while video data frame 502h is the last received video data frame. Additional video data frames 502 may be included in video data stream 500, including tens, hundreds, thousands, and millions of additional video data frames 502. Video data frames 502 may be received sequentially by a video receiver and display device to be sequentially displayed as video.

Referring back to FIG. 4, corrupted frame detector 402 is configured to detect at least one corrupted video data frame in first data stream 410. For example, as shown in FIG. 5, video data frame 502e may be corrupted (e.g., as indicated by dotted line in FIG. 5). In the example of FIG. 5, a single corrupted video data frame 502e is included in video data stream 500. In other situations, multiple video data frames received sequentially may be corrupted. For example, FIG. 6 illustrates a graphical representation of a video data stream 600, according to an embodiment. Video data stream 600 is an example of first data stream 410. As shown in FIG. 6, video data stream 600 includes a plurality of video data frames 602a-602p. In this example, six sequentially arranged video data frames 602f-602k are corrupted (the remaining video data frames 602a-602e and 602l-602p are not corrupted in this example). Corrupted frame detector 402 may be configured to detect any number of corrupted video data frames in a received video data stream, such as video data frames 602f-602k.

As shown in FIG. 4, corrupted frame detector 402 generates a corrupted video frame indication 416. Corrupted video frame indication 416 indicates one or more video data frames of first data stream 410 that are detected to be corrupted. For instance, corrupted video frame indication 416 may include a video data frame identifier (e.g., an identification number) for each detected corrupted video data frame. In an embodiment, the video data frame identifier may be a unique video data frame identifier that is typically present in a header or other data structure of each video data frame, or may be any other identifier suitable for identifying the corrupted video data frames. Such identifier may indicate a location (e.g., an order) of the corresponding video data frame in the stream of video data frames of first data stream 410.

In FIG. 4, storage 408 may optionally be present, and may receive first data stream 410, to store the plurality of video data frames streamed therein. Storage 408 may be included in video data processing module 400 (as shown in FIG. 4), or may be storage of an electronic device (e.g., cell phone, mobile computer, etc.) in which video data processing module 400 is implemented. Storage 408 may include any type of storage mentioned elsewhere herein, or otherwise known, such as one or more memory devices, hard disk drives, etc.

Replacement frame generator 404 receives corrupted video frame indication 416. Replacement frame generator 404 is configured to generate replacement video data frame(s) corresponding to each corrupted video data frame indicated by corrupted video frame indication 416. In an embodiment, replacement frame generator 404 may be configured to generate the replacement video data frame(s) based on a non-corrupted video data frame received in first data stream 410 prior to the corrupted video data frame(s). Replacement frame generator 404 may access storage 408 to retrieve the non-corrupted video data frame received immediately prior to the first corrupted video data frame indicated by corrupted video frame indication 416, for processing into replacement video data frames.

For example, referring to FIG. 5, replacement frame generator 404 may generate a replacement video data frame for corrupted video data frame 502e based on non-corrupted video frame 502d (which is immediately prior to corrupted video data frame 502e). In the example of FIG. 6, replacement frame generator 404 may generate a replacement video data frame for each of corrupted video data frames 602f-602k based on non-corrupted video frame 602e (which is immediately prior to corrupted video data frames 602f-602k).

In another embodiment, replacement frame generator 404 may be configured to generate the replacement video data frame(s) based on a first non-corrupted video data frame received in first data stream 410 prior to the corrupted video data frame(s) and a second non-corrupted video data frame received in first data stream 410 subsequent to the corrupted video data frame(s). For example, referring to FIG. 5, replacement frame generator 404 may generate a replacement video data frame for corrupted video data frame 502e based on non-corrupted video frame 502d (which is immediately prior to corrupted video data frame 502e) and non-corrupted video data frame 502f (which immediately follows corrupted video data frame 502e). In the example of FIG. 6, replacement frame generator 404 may generate a replacement video data frame for corrupted video data frames 602f-602k based on non-corrupted video frame 602e (which is immediately prior to corrupted video data frames 602f-602k) and non-corrupted video frame 6021 (which immediately follows corrupted video data frames 602f-602k).

Replacement frame generator 404 is configured to generate a replacement video data frame to be a modified form of the non-corrupted video data frame(s). In this manner, replacement frame generator 404 generates replacement video data frames to provide a smooth scene transition from the first non-corrupted video data frame, or between the first and second non-corrupted video data frames. As shown in FIG. 4, replacement frame generator 404 generates replacement video data 412. Replacement video data 412 includes the one or more replacement video data frames generated by replacement frame generator 404. In an embodiment, replacement frame generator 404 may include the unique video data frame identifiers for the corrupted video data frames in the corresponding replacement video data frames of replacement video data 412, to identify which corrupted video data frames they replace.

As shown in FIG. 4, frame replacer 406 receives first data stream 410 and replacement video data 412. Note that in the example of FIG. 4, frame replacer 406 is shown receiving first data stream 410 from corrupted frame detector 402, although in other embodiments, frame replacer 406 may receive first data stream 410 directly, or through storage 408. Frame replacer 406 is configured to replace each corrupted video data frame in first data stream 410 with a corresponding replacement video data frame of replacement video data 412 to generate a second data stream 414. For example, in an embodiment, frame replacer 406 may identify corrupted video data frames in first data stream 410 by comparing their video data frame identifiers to those video data frame identifiers included in the received replacement video data frames. Frame replacer 406 may replace the identified corrupted video data frames of first data stream 410 with the corresponding replacement video data frames in second data stream 414, while also including the non-corrupted video data frames of first data stream 410 in second data stream 414, in their original order.

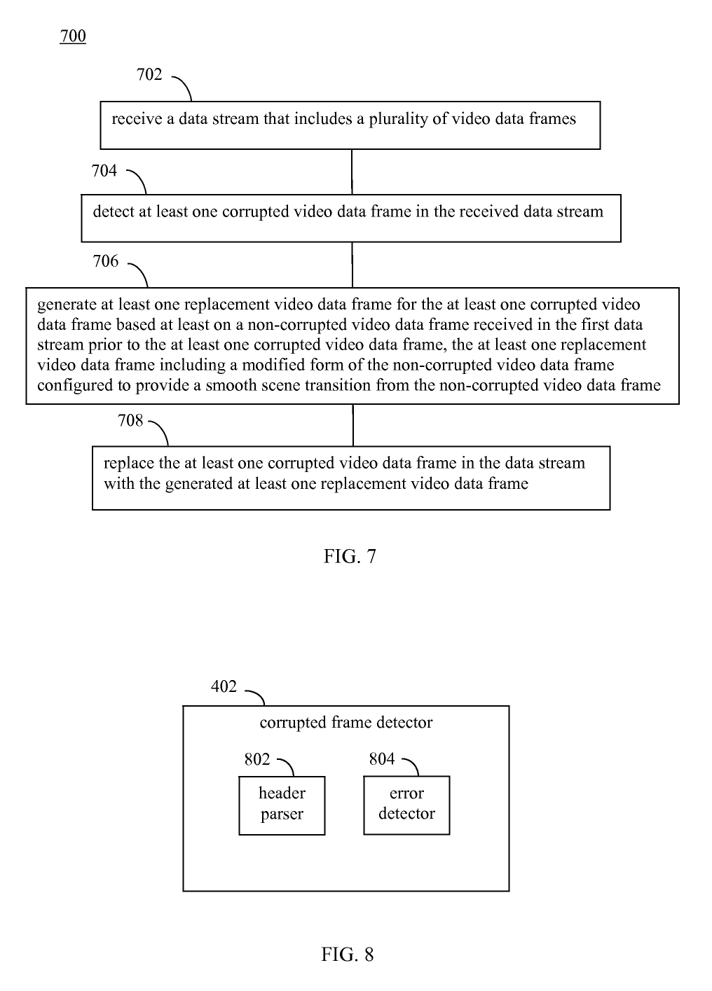

Video data processing module 400 may perform its functions in various ways. FIG. 7 shows a flowchart 700 for video data delivery, according to an example embodiment. For instance, video data processing module 400 may operate according to FIG. 7. Other structural and operational embodiments will be apparent to persons skilled in the relevant art(s) based on the discussion regarding flowchart 700. Flowchart 700 is described as follows.

In step 702, a data stream is received that includes a plurality of video data frames. For example, as shown in FIG. 4, corrupted frame detector 402 may be configured to receive first data stream 410, which includes a plurality of video data frames. Examples of first data stream 410 are shown in FIG. 5 (video data stream 500) and FIG. 6 (video data stream 600).

In step 704, at least one corrupted video data frame is detected in the received data stream. For example, corrupted frame detector 402 may be configured to detect at least one corrupted video data frame in received first data stream 410, and to indicate the corrupted video data frame(s) in corrupted video data frame indication 416. Referring to FIG. 5, corrupted frame detector 402 may detect video data frame 502e as corrupted. As a result, corrupted frame detector 402 may indicate video data frame 502e in corrupted video data frame indication 416 (e.g., by a unique frame indicator for video data frame 502e). Referring to FIG. 6, corrupted frame detector 402 may detect each of video data frames 602f-602k as corrupted, and may indicate video data frames 602f-602k in corrupted video data frame indication 416 (e.g., by unique frame indicators for each of data frames 602f-602k).

Corrupted frame detector 402 may be configured in any manner to detect corrupted video data frames in first data stream 410, including by detecting missing data and/or erroneous data for the received video data frames, and/or detecting that video data frames were not received in their entirety. For instance, FIG. 8 shows a block diagram of corrupted frame detector 402, according to an example embodiment. As shown in FIG. 8, corrupted frame detector 402 may include a header parser 802 and an error detector 804. In an embodiment, header parser 802 is configured to parse one or more headers of each video data frame received in first data stream 410. For example, each video data frame may include a frame header, and may include one or more slice headers, microblock headers, etc. Header parser 802 may be configured to parse such headers for error checking/correction information, including parity bits, checksums, CRC (cyclic redundancy check) bits, an expected number of data units (e.g., slices or microblocks), etc. Error detector 804 is configured to receive the error checking/correction information from header parser 802, and to perform comparisons and/or calculations on data received in the corresponding frame, slice, microblock, etc., to determine whether a data error has occurred with respect to a video data frame. For example, if an expected number of frames and/or data units was not received, error detector 804 may indicate the corresponding video data frame(s) as corrupted. If a checksum or other type of calculation fails (e.g., the calculated value does not match the corresponding error checking/correction information), error detector 804 may indicate the corresponding video data frame as corrupted.

Referring back to FIG. 7, in step 706, at least one replacement video data frame is generated for the at least one corrupted video data frame based at least on a non-corrupted video data frame received in the first data stream prior to the at least one corrupted video data frame, the at least one replacement video data frame including a modified form of the non-corrupted video data frame configured to provide a smooth scene transition from the non-corrupted video data frame. As described above, replacement frame generator 404 is configured to generate one or more replacement video data frame(s), which are output in replacement video data 412. Replacement frame generator 404 may generate a replacement video data frame for each video data frame indicated as corrupted by corrupted video data frame indication 416.

In one embodiment, replacement frame generator 404 may be configured to generate replacement video data frames based on a non-corrupted video data frame received in first data stream 410 prior to receiving the corrupted video data frames. For instance, with respect to FIG. 5, replacement frame generator 404 may generate a replacement video data frame for corrupted video data frame 502e based on non-corrupted video frame 502d. In the example of FIG. 6, replacement frame generator 404 may generate a replacement video data frame for each of corrupted video data frames 602f-602k based on non-corrupted video frame 602e.

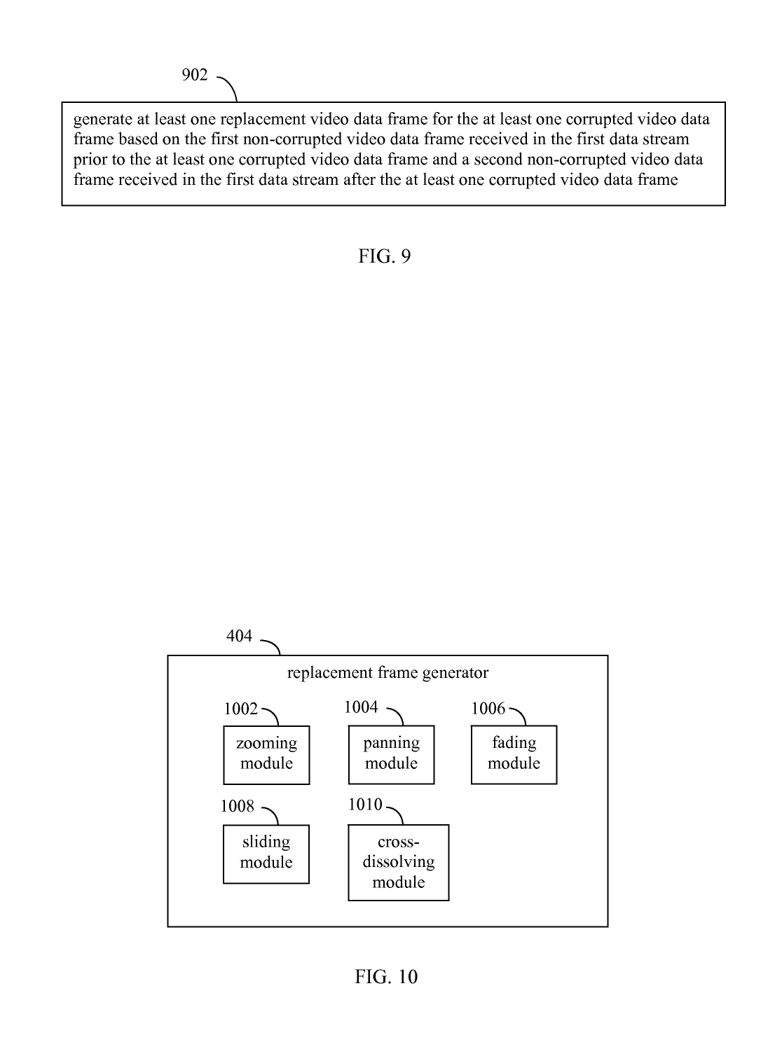

In another embodiment, replacement frame generator 404 may be configured to generate replacement video data frames based non-corrupted video data frames received in first data stream 410 prior to and after receiving the corrupted video data frames. For example, in an embodiment, step 706 of flowchart 700 may be performed according to step 902 shown in FIG. 9. In step 902, at least one replacement video data frame is generated for the at least one corrupted video data frame based on the first non-corrupted video data frame received in the first data stream prior to the at least one corrupted video data frame and a second non-corrupted video data frame received in the first data stream after the at least one corrupted video data frame. For example, referring to FIG. 5, replacement frame generator 404 may generate a replacement video data frame for corrupted video data frame 502e based on non-corrupted video frame 502d and non-corrupted video data frame 502f. In the example of FIG. 6, replacement frame generator 404 may generate replacement video data frames for each of corrupted video data frames 602f-602k based on non-corrupted video frame 602e and non-corrupted video frame 6021.

Referring back to flowchart 700 in FIG. 7, in step 708, the at least one corrupted video data frame is replaced in the data stream with the generated at least one replacement video data frame. For instance, as shown in FIG. 4, frame replacer 406 receives first data stream 410 and replacement video data 412. Frame replacer 406 is configured to replace each corrupted video data frame in first data stream 410 with a corresponding replacement video data frame of replacement video data 412 to generate a second data stream 414 (e.g., as identified according to the video data frame identifiers included in the received replacement video data frames). Frame replacer 406 includes the non-corrupted video data frames of first data stream 410 in second data stream 414, as well as replacing any identified corrupted video data frames with the corresponding replacement video data frames received in replacement video data 412.

### Example Embodiments for Transition Effects in Replacement Images

As described above, in an embodiment, replacement frame generator 404 may be configured to generate replacement video data frames as modified forms of the prior-received and/or subsequently received non-corrupted video data frames. Replacement frame generator 404 may be configured to modify non-corrupted video data frames in various ways to generate replacement video data frames, including by applying one or more video transition effects to the non-corrupted video data frames to generate the replacement video data frames. The video transition effects are applied in a manner that the replacement video data frames provide a smooth motion (non-freeze frame) transition from the prior non-corrupted video data frame, and optionally to the subsequent non-corrupted video data frame.

For instance, FIG. 10 shows a block diagram of replacement frame generator 404, according to an example embodiment. As shown in FIG. 10, replacement frame generator 404 includes a zooming module 1002, a panning module 1004, a fading module 1006, a sliding module 1008, and a cross-dissolving module 1010. Zooming module 1002, panning module 1004, fading module 1006, sliding module 1008, and cross-dissolving module 1010 are respectively configured to apply smooth motion transitions in the form of zooming in/out, panning, fading out/in, sliding, and cross-dissolving. Any combination of one or more of zooming module 1002, panning module 1004, fading module 1006, sliding module 1008, and cross-dissolving module 1010 may be present in replacement frame generator 404, in embodiments, as well as further/alternative modules configured to perform further transition effects, as would be known to persons skilled in the relevant art(s). The modules shown in FIG. 10 are provided for purposes of illustration, and any alternative and/or further types of transition modules (e.g., that may be known to video editor personnel) may be included in replacement frame generator 404. Furthermore, any one or more of zooming module 1002, panning module 1004, fading module 1006, sliding module 1008, and cross-dissolving module 1010 may be present in (e.g., “built-in”) an electronic device in which video data processing module 400 is implemented. In such an embodiment, replacement frame generator 404 may access any one or more of these elements external to video data processing module 400. These elements of replacement frame generator 404 of FIG. 10 are each described as follows.

### Zoom Embodiments

Zooming module 1002 is configured to enable replacement video data frames to be generated that are versions of non-corrupted video data frames modified with zooming in and/or zooming out effects. For example, zooming module 1002 may receive a non-corrupted video data frame (e.g., video data frame 502d in FIG. 5, or video data frame 602e in FIG. 6), and may perform a zoom effect on the received non-corrupted video data frame to generate a replacement video data frame for a corrupted video data frame. If a sequence of corrupted video data frames is received, zooming module 1002 may perform zoom effects of increasing and/or decreasing degrees of zoom on the non-corrupted video data frame to generate a corresponding sequence of replacement video data frames. In embodiments, the zoom effects may be performed on non-corrupted video data frames received before and/or after the corrupted video data frame to generate the replacement video data frame(s).

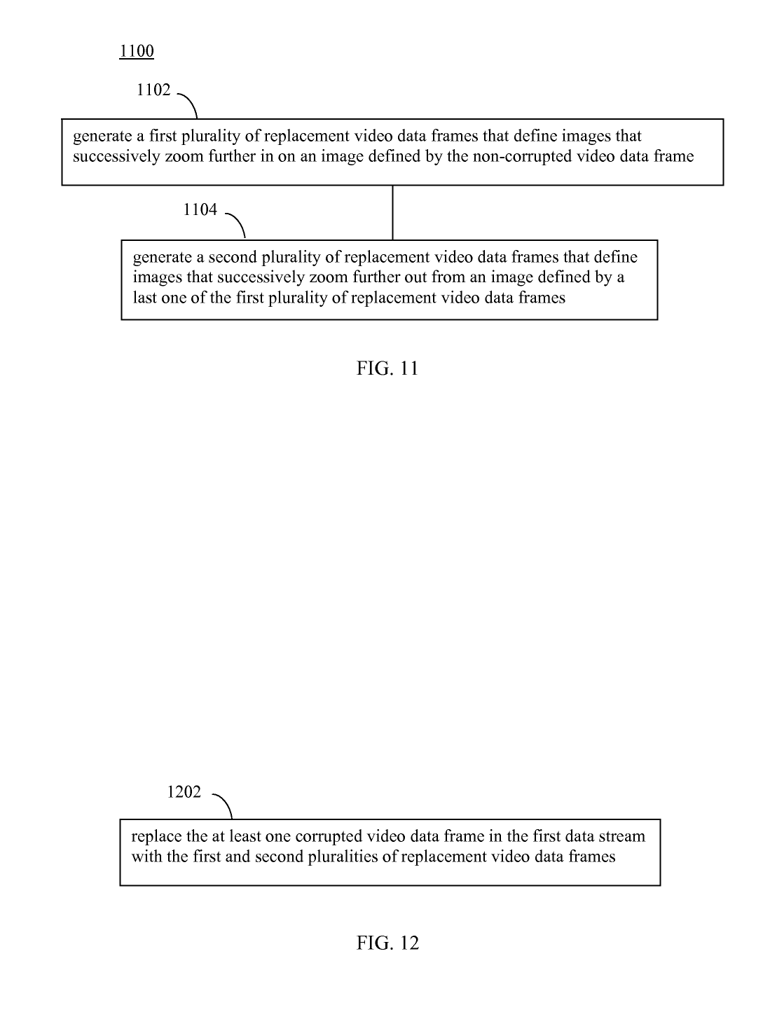

For instance, FIG. 11 shows a flowchart 1100 for generating replacement video data frames having zoom effects, according to an example embodiment. In an embodiment, zooming module 1002 may operate according to flowchart 1100, which is described as follows. In step 1102, a first plurality of replacement video data frames is generated that define images that successively zoom further in on an image defined by the non-corrupted video data frame. For example, zooming module 1002 may perform a digital zoom technique to decrease (narrow) the apparent angle of view of a non-corrupted video data frame image. According to one technique, the non-corrupted video data frame image may be cropped down to a central image region having a same aspect ratio as the original image, and interpolation may be performed on the cropped image to expand the cropped image to have the same pixel dimensions as the original image, to generate a replacement video data frame. This technique may be performed repeatedly on the non-corrupted video data frame beginning with a lowest degree of zoom, and with a successively increasing degree of zoom, to generate a first plurality of replacement video data frames to replace a first sequence of corrupted video data frames.

In step 1104, a second plurality of replacement video data frames is generated that define images that successively zoom further out from an image defined by a last one of the first plurality of replacement video data frames. Subsequent to performing the digital zoom-in technique of step 1102 on the non-corrupted video data frame, zooming module 1002 may perform the digital zoom technique described above repeatedly on the non-corrupted video data frame beginning with a highest degree of zoom, and with a successively decreasing degree of zoom, to generate a second plurality of replacement video data frames with increasing zoom-out to replace a second sequence of corrupted video data frames.

For example, referring to FIG. 6, step 1102 may be performed on non-corrupted video data frame 602e to generate a sequence of replacement video data frames having an increasing degree of zoom to replace corrupted video data frames 602f-602h. Step 1104 may be performed on non-corrupted video data frame 602e to generate a sequence of replacement video data frames having a decreasing degree of zoom to replace corrupted video data frames 602i-602k. In this manner, a smooth motion transition is provided from non-corrupted video data frame 602e that zooms in on non-corrupted video data frame 602e over three video data frames, and then zooms out from non-corrupted video data frame 602e over three video data frames. The replacement video data frames improve the user experience watching the video, because the user views the zoom-in and zoom-out of non-corrupted video data frame 602e rather than viewing the images corresponding corrupted video data frames 602f-602k. Furthermore, the apparent motion included in the replacement video data frames (e.g., due to the zooming in and out in this embodiment) aids in disguising the replacement video data frames to the user, causing the replacement video data frames to appear to be a dynamic portion of the video.

Note that zooming module 1002 may vary the generated zoom effects in any manner. For instance, any rate of zoom in and out may be used. Flowchart 1100 may be repeated any number of times, to generated replacement video data frames providing a repeated zoom in and out effect for a particular sequence of corrupted video data frames. In another example, only step 1102 may be performed, or only step 1104 may be performed, such that the replacement video data frames provide a single zoom direction (either zoom in or zoom out) for a sequence of corrupted video data frames. In still another embodiment, the non-corrupted video data frame subsequent to the corrupted video data frames (e.g., video data frame 6021 in FIG. 6) may be used to generate the replacement video data frames in flowchart 1100. In still another embodiment, step 1102 may be performed using the prior non-corrupted video data frame (e.g., frame 602e in FIG. 6) to generate the first plurality of replacement video data frames, and step 1104 may be performed using the subsequent non-corrupted video data frame (e.g., frame 6021 in FIG. 6) to generate the second plurality of replacement video data frames.

FIG. 12 shows a step 1202 that may be performed during step 708 of flowchart 700 to replace corrupted video data frames, according to an example embodiment. For instance, frame replacer 406 may perform step 1202 subsequent to flowchart 1100. In step 1202, the at least one corrupted video data frame is replaced in the first data stream with the first and second pluralities of replacement video data frames. For example, referring to FIG. 6, the first plurality of replacement video data frames generated during step 1102 may used to replace corrupted video data frames 602f-602h, and the second plurality of replacement video data frames generated during step 1102 may be used to replace corrupted video data frames 602i-602k.

### Pan Embodiments

Panning module 1004 is configured to enable replacement video data frames to be generated that are versions of non-corrupted video data frames modified with panning effects. For example, panning module 1004 may receive a non-corrupted video data frame (e.g., video data frame 502d in FIG. 5, or video data frame 602e in FIG. 6), and may perform a pan effect on the received non-corrupted video data frame to generate a replacement video data frame for a corrupted video data frame. If a sequence of corrupted video data frames is received, panning module 1004 may generate a corresponding sequence of replacement video data frames that progressively pan across the non-corrupted video data frame. In embodiments, the pan effects may be performed on non-corrupted video data frames received before and/or after the corrupted video data frame to generate the replacement video data frame(s).

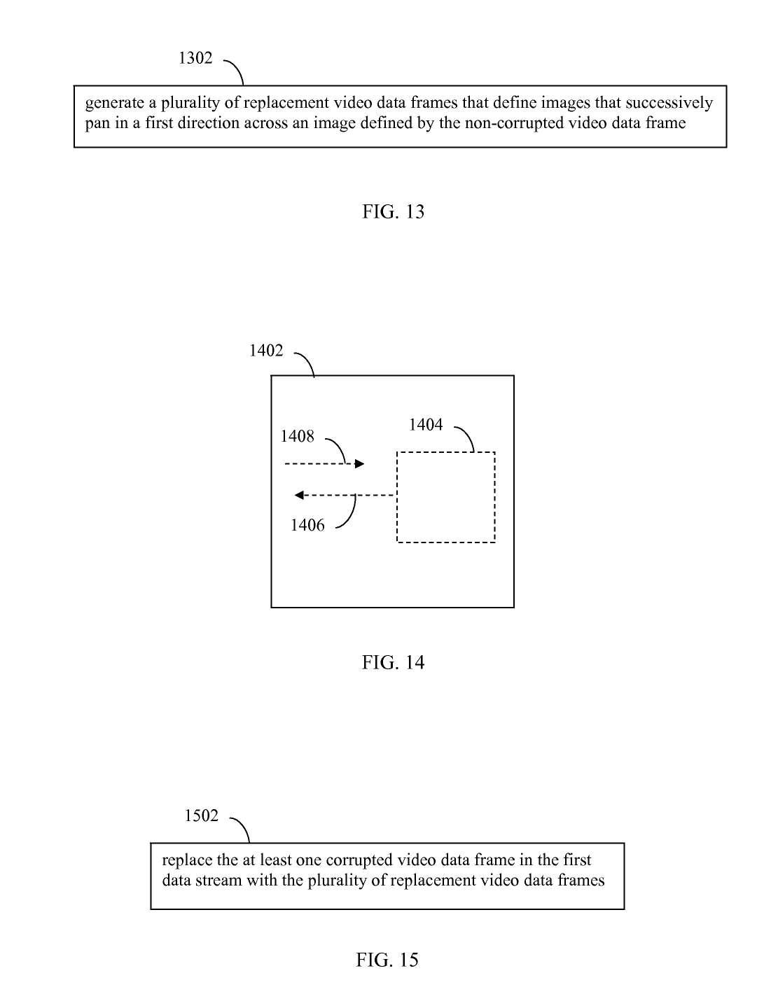

FIG. 13 shows a step 1302 for generating replacement video data frames having pan effects, according to an example embodiment. In an embodiment, panning module 1004 may operate according to step 1302. In step 1302, a plurality of replacement video data frames is generated that defines images that successively pan in a first direction across an image defined by the non-corrupted video data frame. For example, panning module 1004 may perform a digital pan technique to move an angle of view of a non-corrupted video data frame image across the image (e.g., from pixel region to pixel region, which may or may not be overlapping).

FIG. 14 illustrates an example of panning across an image 1402 that may be performed by panning module 1004, according to an embodiment. Image 1402 corresponds to the non-corrupted video data frame. As shown in FIG. 14, a first replacement video data frame may be generated that corresponds to image region 1404. Image region 1404 is a portion of image 1402, and may be located anywhere in image 1402, including along an edge, in a corner, or anywhere else in image 1402. The first replacement video data frame corresponding to image region 1404 may be generated as a zoomed-in portion of image 1402, in a similar manner as described in the previous subsection. Subsequent replacement video data frames may be generated by panning module 1004 that include video data corresponding to image regions of image 1402 having the size of image region 1404, and that successively move away from image region 1404—panning across image 1402—such as in first direction 1406 indicated in FIG. 14. Furthermore, the direction of panning may be changed, such as if an edge of image 1402 is encountered, as indicated by second direction 1408. Thus, step 1302 may be repeated for a second direction, and further directions, as desired.

For example, referring to FIG. 6, step 1302 may be performed on non-corrupted video data frame 602e to generate a sequence of replacement video data frames panning across an image defined by non-corrupted video data frame 602e to replace corrupted video data frames 602f-602k. In this manner, a smooth motion transition is provided from non-corrupted video data frame 602e that pans for six video data frames. The replacement video data frames improve the user experience watching the video, because the user views the panning across the image of non-corrupted video data frame 602e rather than viewing the images corresponding to corrupted video data frames 602f-602k.

Note that panning module 1004 may vary the generated pan effects in any manner. For instance, any rate of panning may be used. In an embodiment, the non-corrupted video data frame subsequent to the corrupted video data frames (e.g., video data frame 6021 in FIG. 6) may be used to generate the replacement video data frames in step 1302. In still another embodiment, step 1302 may be performed using the prior non-corrupted video data frame (e.g., frame 602e in FIG. 6) to generate a first plurality of replacement video data frames, and step 1302 may be performed again using the subsequent non-corrupted video data frame (e.g., frame 6021 in FIG. 6) to generate a second plurality of replacement video data frames. For example, panning module 1004 may be configured to enable a view to be panned from the prior non-corrupted video data frame to the subsequent non-corrupted video data frame (e.g., by connecting/stitching together the prior and subsequent non-corrupted video data frames at the pixel level).

FIG. 15 shows a step 1502 that may be performed during step 708 of flowchart 700, according to an example embodiment. For instance, frame replacer 406 may perform step 1502 subsequent to step 1302. In step 1502, the at least one corrupted video data frame is replaced in the first data stream with the plurality of replacement video data frames. For example, referring to FIG. 6, the plurality of replacement video data frames generated during step 1302 may used to replace corrupted video data frames 602f-602k.

Note that in an embodiment, panning module 1004 shown in FIG. 10 may be included in zooming module 1002. For example, as described above, panning may be performed by zooming in on a region of an image, and generating a sequence of replacement video data frames that are zoomed-in portions of the image. As such, zooming module 1002 may be configured to perform panning by generating the sequence of zoomed-in portions of the image.

### Fade Embodiments

Fading module 1006 is configured to enable replacement video data frames to be generated that are versions of non-corrupted video data frames modified with fading out and/or fading in effects. For example, fading module 1006 may receive a non-corrupted video data frame (e.g., video data frame 502d in FIG. 5, or video data frame 602e in FIG. 6), and may perform a fade effect on the received non-corrupted video data frame to generate a replacement video data frame for a corrupted video data frame. If a sequence of corrupted video data frames is received, fading module 1006 may perform fade effects (e.g., fading in and/or fading out) on the non-corrupted video data frame to generate a corresponding sequence of replacement video data frames. In embodiments, the fade effects may be performed on non-corrupted video data frames received before and/or after the corrupted video data frame to generate the replacement video data frame(s).

For instance, flowchart 1100 shown in FIG. 11 may be modified to provide for successively fading further out in step 1102 (instead of zooming in), and to provide for successively fading in further in step 1104 (instead of zooming out). For example, fading module 1006 may perform a digital fading out technique (in step 1102) to gradually fade out (e.g., gradually darkening, or transitioning to other color) the view of a non-corrupted video data frame image. This may be performed repeatedly on the non-corrupted video data frame beginning with a lowest degree of fade, and with a successively increasing degree of fade, to generate a first plurality of replacement video data frames to replace a first sequence of corrupted video data frames that fade out. Fading module 1006 may perform a digital fading in technique (in step 1104) to gradually fade in (e.g., gradually transitioning back to the original image) the view of the non-corrupted video data frame image. This may be performed repeatedly on the non-corrupted video data frame beginning with a highest degree of fade, and with a successively lower degree of fade, to generate a second plurality of replacement video data frames to replace a second sequence of corrupted video data frames that fade in.

For example, referring to FIG. 6, step 1102 (with fade out) may be performed on non-corrupted video data frame 602e to generate a sequence of replacement video data frames having an increasing degree of fade to replace corrupted video data frames 602f-602h. Step 1104 (with fade in) may be performed on non-corrupted video data frame 602e to generate a sequence of replacement video data frames having a decreasing degree of fade to replace corrupted video data frames 602i-602k. In this manner, a smooth motion transition is provided from non-corrupted video data frame 602e that fades out from non-corrupted video data frame 602e over three video data frames, and then fades back into non-corrupted video data frame 602e over three video data frames. The replacement video data frames improve the user experience watching the video, because the user views the fading out and fading in of non-corrupted video data frame 602e rather than viewing the images corresponding to corrupted video data frames 602f-602k.

Note that fading module 1006 may vary the generated fade effects in any manner. Any rate of fade may be used. Flowchart 1100 may be repeated any number of times with fade, to generate replacement video data frames providing a repeated fade in and out effect for a particular sequence of corrupted video data frames. In another example, only step 1102 may be performed, or only step 1104 may be performed, such that the replacement video data frames provide a single fade direction (either fading out or fading in) for a sequence of corrupted video data frames. In still another embodiment, the non-corrupted video data frame subsequent to the corrupted video data frames (e.g., video data frame 6021 in FIG. 6) may be used to generate the replacement video data frames in flowchart 1100 with fade. In still another embodiment, step 1102 may be performed using the prior non-corrupted video data frame (e.g., frame 602e in FIG. 6) to generate the first plurality of replacement video data frames fading out, and step 1104 may be performed using the subsequent non-corrupted video data frame (e.g., frame 6021 in FIG. 6) to generate the second plurality of replacement video data frames fading in.

### Slide Embodiments

Sliding module 1008 is configured to enable replacement video data frames to be generated that are versions of non-corrupted video data frames modified to be sliding in and/or out of view. For example, sliding module 1008 may receive a non-corrupted video data frame (e.g., video data frame 502d in FIG. 5, or video data frame 602e in FIG. 6), and may perform a slide effect on the received non-corrupted video data frame to generate a replacement video data frame for a corrupted video data frame. If a sequence of corrupted video data frames is received, sliding module 1008 may perform slide effects (e.g., sliding a video data frame image off one edge of the display, and back onto the display from another edge of the display) on the non-corrupted video data frame to generate a corresponding sequence of replacement video data frames. In embodiments, the slide effects may be performed on non-corrupted video data frames received before and/or after the corrupted video data frame to generate the replacement video data frame(s).

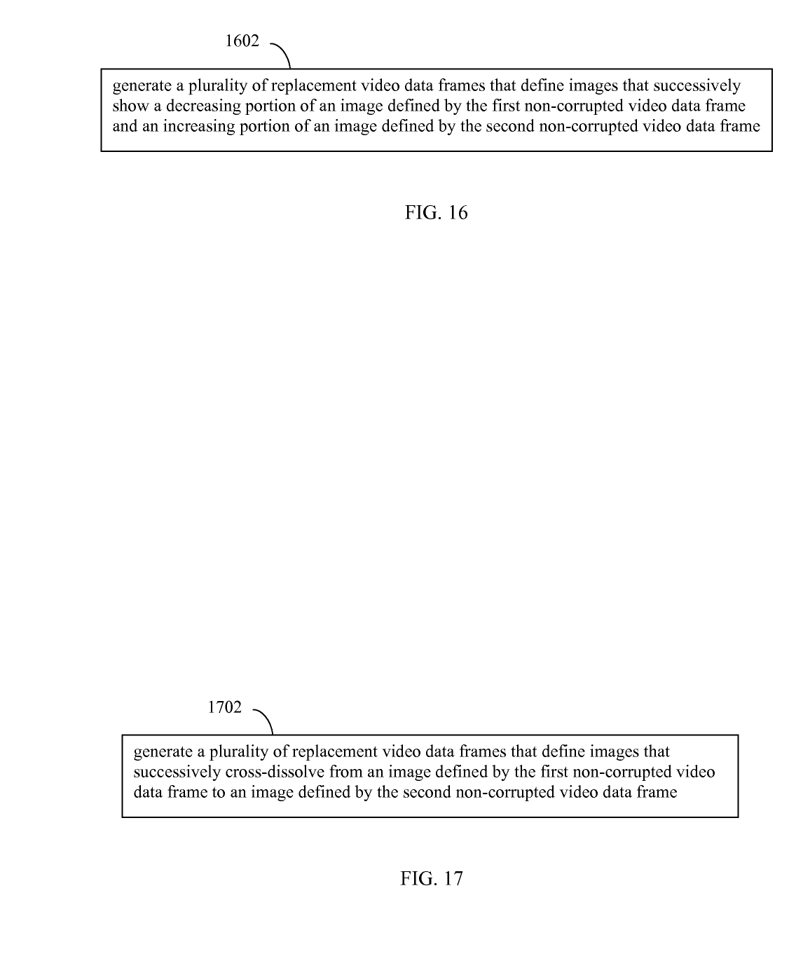

FIG. 16 shows a step 1602 for generating replacement video data frames having slide effects, according to an example embodiment. For instance, sliding module 1008 may operate according to step 1602. In step 1602, a plurality of replacement video data frames is generated that defines images that successively show a decreasing portion of an image defined by the first non-corrupted video data frame and an increasing portion of an image defined by the second non-corrupted video data frame. Sliding module 1008 may perform a digital sliding technique to gradually slide out the view of a first non-corrupted video data frame image (e.g., move a first image from the original position in a direction until it is moved out of view). This may be performed repeatedly on the first non-corrupted video data frame beginning at the original position, successively moving out of view. Simultaneously, sliding module 1008 may perform a digital sliding in technique to gradually slide in the view of a second non-corrupted video data frame image (e.g., move a second image from out of view in the direction until it is in the original position of the first image). This may be performed repeatedly on the second non-corrupted video data frame beginning at an edge, successively moving further the second non-corrupted video data frame image into view, to generate a plurality of replacement video data frames that slide out the first image and slide in the second image to replace a sequence of corrupted video data frames.

For example, referring to FIG. 6, step 1602 may be performed to generate a sequence of replacement video data frames that successively slide out non-corrupted video data frame 602e, and successively slide in non-corrupted video data frame 6021, to replace corrupted video data frames 602f-602k. In this manner, a smooth motion transition is provided from non-corrupted video data frame 602e, which slides out of view, to non-corrupted video data frame 6021, which slides into view. The replacement video data frames improve the user experience watching the video, because the user views the sliding out and in of non-corrupted video data frames 602e and 6021 rather than viewing the images corresponding to corrupted video data frames 602f-602k.

### Cross-Dissolve Embodiments

Cross-dissolving module 1010 is configured to enable replacement video data frames to be generated that are versions of non-corrupted video data frames that cross-dissolve from one into the other. For example, cross-dissolving module 1010 may receive a first non-corrupted video data frame (e.g., video data frame 502d in FIG. 5, or video data frame 602e in FIG. 6) and a second non-corrupted video data frame (e.g., video data frame 502f in FIG. 5, or video data frame 6021 in FIG. 6), and may perform a cross-dissolving effect using the first and second non-corrupted video data frames, to generate one or more replacement video data frames for corresponding corrupted video data frames.

FIG. 17 shows a step 1702 for generating replacement video data frames having cross-dissolve effects, according to an example embodiment. For instance, cross-dissolve module 1010 may operate according to step 1702. In step 1702, a plurality of replacement video data frames is generated that defines images that successively cross-dissolve from an image defined by the first non-corrupted video data frame to an image defined by the second non-corrupted video data frame. Cross-dissolving module 1010 may perform a digital cross-dissolving technique, as would be known to persons skilled in the relevant art(s), to gradually transition from the view of a first non-corrupted video data frame image to a second non-corrupted video data frame image. This may be performed on the first and second non-corrupted video data frames, starting with a larger degree of the first non-corrupted video data frame being present, successively increasing the degree of the second non-corrupted video data frame being present by cross-dissolving, to generate a plurality of replacement video data frames to replace a sequence of corrupted video data frames that cross-dissolve.

For example, referring to FIG. 6, step 1702 may be performed to generate a sequence of replacement video data frames that successively cross-dissolve from non-corrupted video data frame 602e to non-corrupted video data frame 6021, to replace corrupted video data frames 602f-602k. In this manner, a smooth motion transition is provided from non-corrupted video data frame 602e, which dissolves out of view, to non-corrupted video data frame 6021, which dissolves into view. The replacement video data frames improve the user experience watching the video, because the user views the cross-dissolving of non-corrupted video data frames 602e and 6021 rather than viewing the images corresponding to corrupted video data frames 602f-602k.

### Further Example Applications and Embodiments

Embodiments for video data recovery can serve a wide range of video applications, including video telephony/streaming applications. Example advantages may include an improved end-user visual experience (e.g., a smoother display of video), a lower complexity for implementation, little to no overhead for bandwidth utilization, and an applicability to a wide range of multimedia applications, such as video telephony, video streaming, and mobile TV. Example applications include videos in entertainment, such as “YouTube” user created videos, conversational videos, etc.

Video data processing module 400, corrupted frame detector 402, replacement frame generator 404, frame replacer 406, header parser 802, error detector 804, zooming module 1002, panning module 1004, fading module 1006, sliding module 1008, and cross-dissolving module 1010 may be implemented in hardware, software, firmware, or any combination thereof. For example, video data processing module 400, corrupted frame detector 402, replacement frame generator 404, frame replacer 406, header parser 802, error detector 804, zooming module 1002, panning module 1004, fading module 1006, sliding module 1008, and/or cross-dissolving module 1010 may be implemented as computer program code configured to be executed in one or more processors. Alternatively, video data processing module 400, corrupted frame detector 402, replacement frame generator 404, frame replacer 406, header parser 802, error detector 804, zooming module 1002, panning module 1004, fading module 1006, sliding module 1008, and/or cross-dissolving module 1010 may be implemented as hardware logic/electrical circuitry.

### Example Computer Program Embodiments

Any apparatus or manufacture comprising a computer useable or readable medium having control logic (software) stored therein is referred to herein as a computer program product or program storage device. This includes, but is not limited to, a computer, computer main memory, computer secondary storage devices, removable storage units, etc. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for video data processing module 400, corrupted frame detector 402, replacement frame generator 404, frame replacer 406, header parser 802, error detector 804, zooming module 1002, panning module 1004, fading module 1006, sliding module 1008, and/or cross-dissolving module 1010, flowchart 700, step 902, flowchart 1100, step 1202, step 1302, step 1502, step 1602, and/or step 1702 (including any one or more steps of flowcharts 700 and 1100), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

According to an example embodiment, a mobile device may execute computer-readable instructions to generate replacement video data frames providing smooth scene transitions, as further described elsewhere herein, and as recited in the claims appended hereto.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents

What is claimed is:

1. A method for video data delivery, comprising:
receiving a first data stream that includes a plurality of video data frames;
detecting at least one corrupted video data frame in the first data stream;
generating at least one replacement video data frame for the at least one corrupted video data frame based at least on a non-corrupted video data frame received in the first data stream prior to the at least one corrupted video data frame, the at least one replacement video data frame including a modified form of the non-corrupted video data frame configured to provide a smooth scene transition from the non-corrupted video data frame; and
replacing the at least one corrupted video data frame in the first data stream with the generated at least one replacement video data frame to generate a second data stream.

2. The method of claim 1, wherein said generating comprises:
generating a replacement video data frame for each corrupted video data frame detected in the first data stream to generate a plurality of replacement video data frames that provide the smooth scene transition.

3. The method of claim 1, wherein said generating comprises:
configuring the smooth scene transition to be at least one of zooming, panning, or fading from the non-corrupted video data frame.

4. The method of claim 1, wherein said generating comprises:
generating a first plurality of replacement video data frames that define images that successively zoom in on an image defined by the non-corrupted video data frame, and
generating a second plurality of replacement video data frames that define images that successively zoom out from an image defined by a last one of the first plurality of replacement video data frames; and
wherein said replacing comprises:
replacing the at least one corrupted video data frame in the first data stream with the first and second pluralities of replacement video data frames.

5. The method of claim 1, wherein said generating comprises:
generating a plurality of replacement video data frames that define images that successively pan in a first direction across an image defined by the non-corrupted video data frame; and
wherein said replacing comprises:
replacing the at least one corrupted video data frame in the first data stream with the plurality of replacement video data frames.

6. The method of claim 1, wherein said generating comprises:
generating a first plurality of replacement video data frames that define images that successively fade out from an image defined by the non-corrupted video data frame, and
generating a second plurality of replacement video data frames that define images that successively fade in from an image defined by a last one of the first plurality of replacement video data frames; and
wherein said replacing comprises:
replacing the at least one corrupted video data frame in the first data stream with the first and second pluralities of replacement video data frames.

7. The method of claim 1, wherein said generating comprises:
generating the at least one replacement video data frame for the at least one corrupted video data frame based on the non-corrupted video data frame received in the first data stream prior to the at least one corrupted video data frame and a second non-corrupted video data frame received in the first data stream after the at least one corrupted video data frame, the at least one replacement video data frame being configured to provide a smooth scene transition between the non-corrupted video data frame received in the first data stream prior to the at least one corrupted video data frame and the second non-corrupted video data frame received in the first data stream after the at least one corrupted video data frame.

8. The method of claim 7, wherein generating comprises:
configuring the smooth scene transition to be at least one of zooming, panning, fading, cross-dissolving, or sliding from the non-corrupted video data frame received in the first data stream prior to the at least one corrupted video data frames to the second non-corrupted video data frame received in the first data stream after the at least one corrupted video data frame.

9. A video data processing module, comprising:
a corrupted frame detector configured to receive a first data stream that includes a plurality of video data frames, and to detect at least one corrupted video data frame in the received first data stream;
a replacement frame generator configured to generate at least one replacement video data frame for the at least one corrupted video data frame based on a non-corrupted video data frame received in the first data stream prior to the at least one corrupted video data frame, the at least one replacement video data frame including a modified form of the non-corrupted video data frame configured to provide a smooth scene transition from the non-corrupted video data frame; and
a frame replacer configured to replace the at least one corrupted video data frame in the first data stream with the generated at least one replacement video data frame to generate a second data stream.

10. The video data processing module of claim 9, wherein the replacement frame generator is configured to generate a replacement video data frame for each corrupted video data frame detected in the first data stream to generate a plurality of replacement video data frames that provide the smooth scene transition.

11. The video data processing module of claim 9, wherein the replacement frame generator is configured to configure the smooth scene transition to be at least one of zooming, panning, fading, or sliding from the non-corrupted video data frame.

12. The video data processing module of claim 9, wherein the replacement frame generator is configured to generate a first plurality of replacement video data frames that define images that successively zoom in on an image defined by the non-corrupted video data frame, and to generate a second plurality of replacement video data frames that define images that successively zoom out from an image defined by a last one of the first plurality of replacement video data frames; and
wherein the frame replacer is configured to replace the at least one corrupted video data frame in the first data stream with the first and second pluralities of replacement video data frames.

13. The video data processing module of claim 9, wherein the replacement frame generator is configured to generate a plurality of replacement video data frames that define images that successively pan in a first direction across an image defined by the non-corrupted video data frame; and
wherein the frame replacer is configured to replace the at least one corrupted video data frame in the first data stream with the plurality of replacement video data frames.

14. The video data processing module of claim 9, wherein the replacement frame generator is configured to generate a first plurality of replacement video data frames that define images that successively fade out from an image defined by the non-corrupted video data frame, and to generate a second plurality of replacement video data frames that define images that successively fade in from an image defined by a last one of the first plurality of replacement video data frames; and
wherein the frame replacer is configured to replace the at least one corrupted video data frame in the first data stream with the first and second pluralities of replacement video data frames.

15. The video data processing module of claim 9, wherein the replacement frame generator is configured to generate the at least one replacement video data frame for the at least one corrupted video data frame based on the non-corrupted video data frame received in the first data stream prior to the at least one corrupted video data frame and a second non-corrupted video data frame received in the first data stream after the at least one corrupted video data frame, the at least one replacement video data frame being configured to provide a smooth scene transition between the non-corrupted video data frame received in the first data stream prior to the at least one corrupted video data frame and the second non-corrupted video data frame received in the first data stream after the at least one corrupted video data frame.

16. The video data processing module of claim 15, wherein the replacement frame generator is configured to configure the smooth scene transition to be at least one of zooming, panning, fading, cross-dissolving, or sliding from the non-corrupted video data frame received in the first data stream prior to the at least one corrupted video data frames to the second non-corrupted video data frame received in the first data stream after the at least one corrupted video data frame.

17. A computer program product comprising a computer-readable medium having computer program logic recorded thereon for enabling a processor to deliver video data, comprising:
first computer program logic means for enabling the processor to detect at least one corrupted video data frame in a received first data stream that includes a plurality of video data frames;
second computer program logic means for enabling the processor to generate at least one replacement video data frame for the at least one corrupted video data frame based on a non-corrupted video data frame received in the first data stream prior to the at least one corrupted video data frame, the at least one replacement video data frame including a modified form of the non-corrupted video data frame configured to provide a smooth scene transition from the non-corrupted video data frame; and
third computer program logic means for enabling the processor to replace the at least one corrupted video data frame in the first data stream with the generated at least one replacement video data frame to generate a second data stream.
